(19) United States
(12) Patent Application Publication
(10) Pub. No.: US 2014/0227676 A1
(43) Pub. Date: Aug. 14, 2014

(54) INTERACTIVE EDUCATION AND ENTERTAINMENT SYSTEM HAVING DIGITAL AVATAR AND PHYSICAL TOY

(71) Applicant: Science Ranger Corp., New York, NY (US)

(72) Inventors: Hyduke Noshadi, Sherman Oaks, CA (US); Cyrus Alexander Azima, San Francisco, CA (US)

(73) Assignee: Science Ranger Corp., New York, NY (US)

(21) Appl. No.: 14/178,123

(22) Filed: Feb. 11, 2014

Related U.S. Application Data
(60) Provisional application No. 61/763,400, filed on Feb. 11, 2013.

(51) Int. Cl. G09B 5/02

(52) U.S. Cl. CPC G09B 5/02
USPC 434/365

(57) ABSTRACT

An interactive educational and entertainment system comprised of a toy as an avatar in the physical world and a digital environment, where the represented avatar has a corresponding physical toy. The system enables three way communications among the player, the physical toy and the digital environment or the avatar presented in digital environment. The physical toy acts as a bridge to transfer the state in physical world to digital world and vice versa. The physical toy is capable of measuring the activities and actions of physical player directly or indirectly, transfer the collected data to the virtual space and also use the recommendations from virtual space to engage/coach the human player.

### CROSS-REFERENCE TO RELATED APPLICATION

This application claims priority to U.S. Provisional Application Ser. No. 61/763,400 filed Feb. 11, 2013, and is incorporated herein by reference in its entirety.

### BACKGROUND

Ordinary physical toys come in many shapes and sizes and many have features that allow the user to interact with sights, sounds and positioning provided by the toy and some offer a limited interactive experience with the user. Online games and toys are also known where digital representations of toys appear on screen in an online environment and can be manipulated by the user and provide some level of feedback.

In digital environment simulations, the user can interact with a program resident on a computer system that provides a variety of input and feedback. Computer games are well known wherein the user interacts with a digital avatar and can manipulate the avatar in a variety of ways to interact with a digital environment. These systems typically involve a variety of characters and interactive game experiences where conditions provided by the digital environment depend on input from the user and the preexisting algorithms that apply a set of rules to the online environment.

### SUMMARY

In this system the physical player interacts with a physical toy that has a corresponding online avatar that, in itself, exists in an online environment and has operations and characteristics dictated by a system containing certain algorithms that control the online environment, the online avatar and that have, in turn an interaction with the physical toy. The online avatar has a defined correlation to the physical toy, but exists in an online environment wherein interaction between the physical player and the online avatar is reflected in the online environment.

The physical toy has sensing channels including such parameters as distance, touch, activity, sound and others that measure interactions with the physical player. The physical toy has means to communicate optimum parameter sets to the physical player. The toy also has means to communicate with the online system such that the physical device provides a connection to the system.

The physical toy also has a correlation to the online avatar and data recording the physical toy also features online data collection including sight, sound and motion parameters that either may be provided by a dedicated data collection and storing method or may be with a separate device. An ideal separate device would be a smart device such as a cell phone that has data collection, sound, and other storage techniques to measure and record the interaction between the physical player and the physical toy. A separate smart device may have a corresponding plug and socket relationship with a receptacle or port on the physical toy.

### BRIEF DESCRIPTION OF THE DRAWINGS

FIG. 1 illustrates an exemplary diagram of the disclosed system.

FIG. 2 illustrates an exemplary diagram of one of the embodiments of the apparatus.

FIG. 3 illustrates an exemplary diagram of the virtual game environment and interaction with the user and apparatus.

FIG. 4 illustrates an exemplary top-level block diagram of the architecture of the system.

FIG. 5 illustrates the method for filtering, segmenting and classifying received sensor data.

FIG. 6 illustrates the method for determining progress towards completion of defined activities.

FIG. 7 illustrates the method of optimizing energy consumption by the apparatus during sensor data collection.

FIG. 8 illustrates the method of classification of data as actionable or non-actionable events to determine transmission of data.

FIG. 9 illustrates the method of determining a virtual storyline to help a user achieve a predefined goal.

FIG. 10 illustrates the various methods for information mining.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

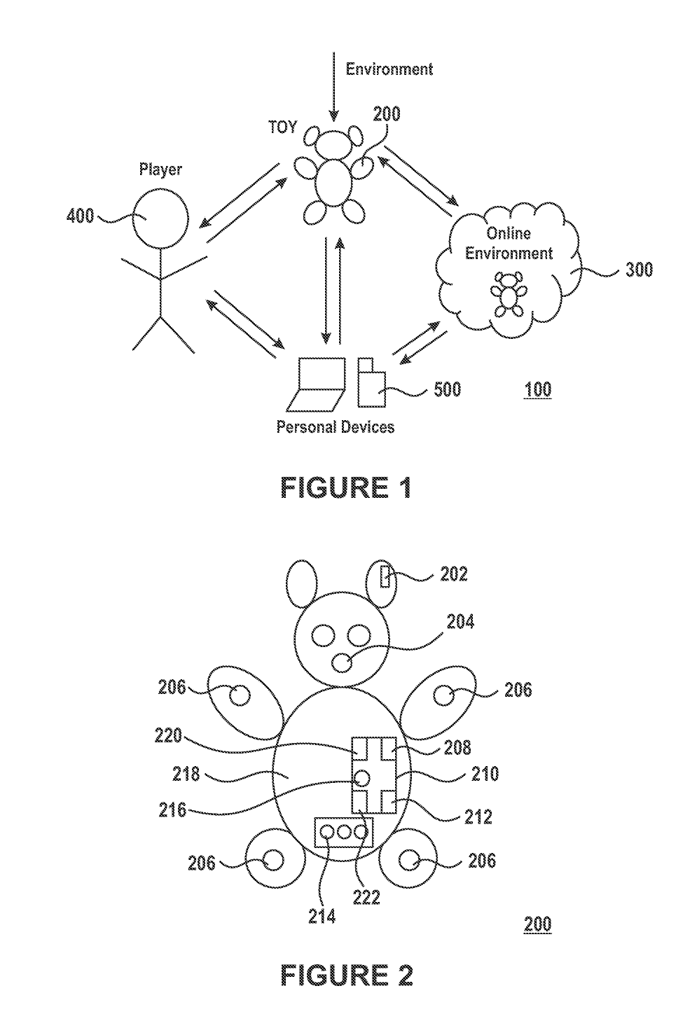

FIG. 1 illustrates an exemplary diagram of the disclosed system. In one embodiment the system 100 is comprised of a physical toy (apparatus) 200, an online environment 300, a user 400 and personal electronic device 500. A user 400 interacts with a physical toy 200 that has sensing, data processing, data collection and storage, aggregation and multiple communication capabilities. The physical toy 200 can communicate with a personal computer, tablet or a personal electronic device 500 to communicate with a virtual environment 300. The personal electronic device 500 can provide more extensive data processing capabilities and may transfer collected, raw or processed information and data assembled from the player's interaction with the physical toy 200. A digital avatar 302 that represents and corresponds to the physical toy 200 is used in an interactive manner that includes unilateral, bilateral and multi-lateral transfer of data and information to create an interactive gaming experience. The game is adjusted and calibrated based on collected data from the user 400. For example, an online/virtual experience, such as when a user 400 plays an on-line/virtual game and gains a score at the end of a session, yields a result as a level of progress and such result along with collected data from the user 400 is also used to provide feedback to the user 400 through the physical toy 200. The feedback may include instructions for the user 400 to adjust daily activity, for example by coaching the player to interact in specified ways with the physical toy 200.

The interactive educational and entertainment system 100 can be calibrated through proprietary software resident on a personal computer or an app on a tablet or other personal electronic device 500. A user 400 can select the goals and desired interactions between the user 400 and the physical toy 200 from an assortment of options presented in the software. After the user 400 selects the desired goals and interactions, the system will calibrate the physical toy 200 with instructions on how to best achieve those desired goals. This calibration can be accomplished by connection of the physical toy 200 to a charging station/data transfer device or through a wireless connection between the portable electronic device 500 and the physical toy 200. The calibration will initially establish the sensor collection strategy 810 which will be employed by physical toy 302. The portable electronic device 500 can adjust the sensor collection strategy 810 based on feedback received from the progress towards accomplishment of the stated goals.

FIG. 2 illustrates an exemplary diagram of one of the embodiments of the apparatus. In one embodiment, the physical toy 200 is a toy bear. The physical toy 200 may be constructed using soft or hard materials and may have a part or fixture 216 to electronically and physically connect to an embedded smart device 210 with processing 208, sensing 206, storage 214 and communication capabilities 204. The smart device 210 may be a separate device such as a smart phone, tablet, music player, recorder or other processing unit 208 capable of receiving or transmitting data from the system described herein. A set of sensors 206 are connected to different parts of physical toy 200, either as externally connected sensors or embedded inside the physical toy 200. The sensors 206 are electrically connected to smart device (or processing unit) 208 using external IO pins 214 or some other wired or wireless connection means. The physical toy 200 also incorporates a positioning system (i.e., GPS), accelerometers, magnetometer and a gyroscope. In addition the physical toy 200 has a set of speakers and microphone 204, which is used for two way communications and narration between physical user 400 and physical toy 200. The speakers and microphone 204 or other communication device may be permanently dedicated to the physical toy 200 or integrated by communication with the smart device 210. The speakers can be affixed at any location on the physical toy 200.

In another embodiment, the physical toy 200 is comprised of an apparatus is similar to a watch. Like the physical toy 200, the watch is comprised of a processing unit, data storage unit, microphone, speakers, a plurality of sensing units, an embedded positioning system (i.e., GPS), accelerometers, gyroscopes, magnetometer and a wireless transfer and receiving capability.

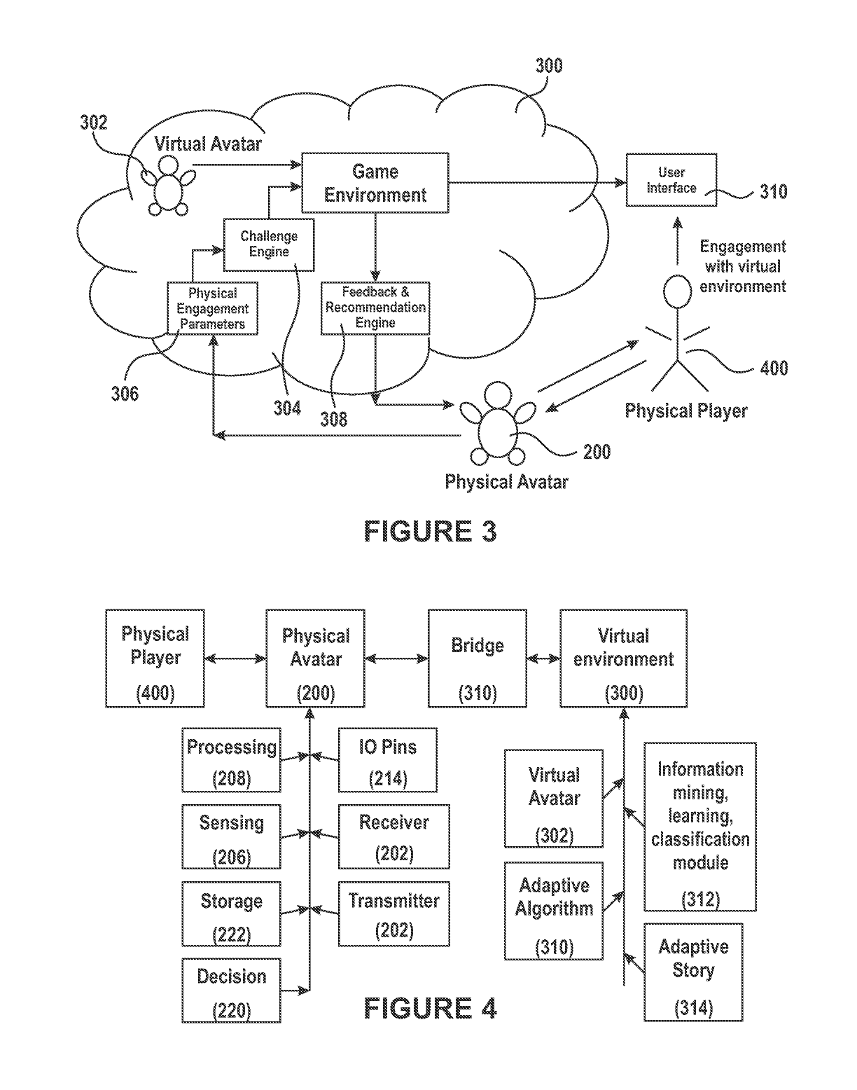

FIG. 3 illustrates an exemplary diagram of the virtual game environment 300 and interaction with the user 400 and apparatus 200. The virtual environment 300 is created through a set of instructions run on a processor of a personal computer, a tablet computer, or various portable electronic devices 500 such as a smart phone. The software may be a proprietary program stored on any computer readable medium and then subsequently installed on any of the above electronic devices. The software may also be downloaded through as an App which can be available in different formats or operating system such as Android and iOS. The software generates a virtual depiction of the physical toy 200 on the display screen on the computer, tablet or portable electronic device 500. The software may utilize the graphics, sound, and touch screen, keyboard, or pointing device of the computer or electronic device as a user interface 310 to control the virtual avatar 302 in the virtual environment 300 and interact with the various virtual games. Various games may be saved on the storage device associated with the computer, tablet or portable electronic device 500. The program is designed to be expandable allowing for downloading various different games or challenges. In addition, the program and App are designed to be updated as various improvements are made to the system. A game in a virtual environment 300 is designed to keep the user 400 engaged in both the real and virtual worlds.

The user 400 sets the desired physical engagement parameters 306 upon device calibration. For example, one configuration may proscribe a parameter with the objective of the user 400 being physically active for ten minutes out of every hour for a period of four hours. After the user 400 selects the physical engagement parameters, the challenge engine 304 determines various challenges to help the user 400 achieve the stated objectives. The challenges are transmitted to physical toy 200 and communicated to the user 400 through either the portable electronic device 500 or the physical toy 200. The user 400 is prompted to participate in several activities in the real world. In one embodiment, a score is determined by a combination of a plurality of real world activities and a plurality of virtual world activities. Score may also be determined by an elapsed time required to complete a specified set of actions. The physical toy 200 measures accomplishment of the challenges. Based on the computational requirements to collect, segment, and classify the activities, the processing is either accomplished by the processor 208 in the physical toy 200 or the sensor data is transmitted to the portable electronic device 500 for processing.

The challenge engine 304 will determine the extent of accomplishment of the challenges. The challenge engine 304 uses collected parameters from the real world, such as sensor data when the user 400 and the physical toy 200 were engaged, as an input to the challenge engine 304 to identify the correct set of challenges to provide to the user 400 for a new session of online gaming. A virtual avatar 302 is thereby representing a unique physical user 400 in online game. In such an environment 300, the virtual avatar 302 is navigated through different games by the physical player 400. The game can be comprised of educational challenges and adventurous segments. The outcome of the online gaming aggregated with collected user signals to provide feedback through the Feedback and Recommendation Engine 308 to coach the physical player 400 to meet a set of objectives generated by the system and communicated to the player through the online environment 300. The feedback and coaching messages are transmitted to the physical toy 200 through a wired or wireless connection. The physical toy 200 communicates the messages to the user 400 through the physical toy's output devices.

FIG. 4 illustrates an exemplary top-level block diagram of the architecture of the system. The physical toy 200 is a toy that can be built using soft or hard materials or combination of both and can be in variety of shapes, sizes and can represent known characters. The toy has a processing unit 208, which is either attached to toy or embedded inside the body of the toy or is connected to the body, using the general purpose input/output (IO) pins 214, or is embedded in an external electronic smart device 210 (such as cell phone, camera, recorder, etc.) connected to the physical toy 200. The toy has a capability to connect a variety of sensors 206, where these sensors are either connected to toy directly or are connected indirectly by an external electronics (for example the accelerometers light sensors, microphones or other sensing implements in a cell phone connected to the toy). The sensors 206 are designed to have plug-and-play connectivity and the system is designed to plug in various sensors 206 into the sensor connectors. A storage medium 222 stores data, either embedded inside or connected through input/output (I/O) pins 214 or inside an external electronic device connected to toy (for example a memory of a smart phone connected to the toy). A decision making module 220, is responsible to apply machine learning, classification, adaptation, data cleaning, encryption, aggregation and fusion to collected data and produces an actionable outcome) that is used to communicate with the physical user 400, or will get transformed to virtual environment 300 to be used in the virtual games experience. One or more receiver units 202 affixed to the body of the physical toy 200 or as part of the embedded portable electronic device receive the medium from physical user 400 or the bridge 310 and are capable of storing or processing received data. The Transmission unit 202 is both receiver and transmitter. The transmission unit 202 can be either a transmitter unit attached to electronic device (i.e., USB Bluetooth) or embedded inside the devices main hardware (i.e., on the board WiFi). The transmitter module can be WiFi, Bluetooth, ZigBee, or any modification or improvement to existing wireless transmission protocol standards. ZigBee is used in applications that require only a low data rate, long battery life, and secure networking. ZigBee has a defined rate of 250 kilobit/s, best suited for periodic or intermittent data or a single signal transmission from a sensor or input device.

The transmitted packets have predefined format, such that the receiver side can perform error checking per packet. One or more transmitter units 202 are capable of transmitting the information to the physical user 400 of through the bridge 310 or directly to the virtual environment 300.

A gateway that connects the physical toy 200 and virtual environment 300 is either part of the physical toy 200 or it is in the form of a charging station. The gateway and bridge 310 are essentially the same. The only difference is that gateway guarantees the connection and data transmission to tablet/cloud environment but the bridge 310 is an intermediate medium that connects the toy 200 wirelessly to the gateway. The charging station charges the physical toy 200. If the electronics inside the physical toy 200 is a phone then it charges the phone. If it is a proprietary hardware then it charges energy source (i.e., batteries) for the hardware. In the embodiment where the toy 200 is a watch, the charging station charges the batteries in the watch. In addition to providing a way to charge the physical toy 200, the charging station provides two-way communication between the toy 200 and the portable electronic device 500 for both data and command transfer. In the virtual environment 300, each physical toy 200 exists and may correspond to one or more virtual avatars 302.

The virtual avatar 302 is a digital representation of the physical toy 200. It can be used in a virtual environment 300 as a graphic representation of the physical toy 200 or may have variations provided to the online environment 300. The virtual environment 300 is capable of following story lines 314, where the story lines 314 are prepared and incorporated in the virtual environment 300. The virtual avatar 302 guided by the physical user 400 takes the journey in the virtual environment 300 to address/overcome challenges or to reach a specific goal. The adaptive algorithm module 310 in virtual environment 300 will be used to adjust the fitness parameters of the virtual avatar 302 based on collected data from the physical toy 200 or a historic performance of the physical toy 200. The information mining, learning, and classification module 312 may also use the same techniques to recommend a new set of activities for the physical player 400 to achieve a set of objectives such as to increase activity levels or to be more social. A machine learning and information mining module 312, which will use all the collected data from a physical player received to the virtual environment directly by the physical toy 200 or indirectly by the bridge 310 may analyze the interaction between the player 400 and the physical toy 200 to learn facts about the user 400 and to use hidden parameters to adaptively change the story 314 in the virtual environment 300 or to propose a new set of activities to both physical 200 and virtual avatars 302, where the goal may be propose series of steps to improve the outcome of a specified goal. In one embodiment, the goal may be controlling the weight of the user 400. In such an end-to-end system, which takes advantage of round trip data aggregation and feedback loop, data and decision information may travel in both directions from the physical toy 200 to the virtual environment 300 or to the virtual avatar 302. Using the data collected from the physical user 400, and data used to coach the user 400 in interactions with the virtual avatar 302, as well as collected data in virtual environment 300 that can be incorporated with received data from physical environment, actionable steps are provided to coach the physical player 400 based on an action taken. The actionable steps may be propagated to the physical toy 200 and communicated with the physical user 400 through the physical toy 200. The communication between physical player 400 and virtual avatar 302 happens by virtual environments 10 devices, light sensor, microphone, and speakers.

Activity Recognition/Learning:

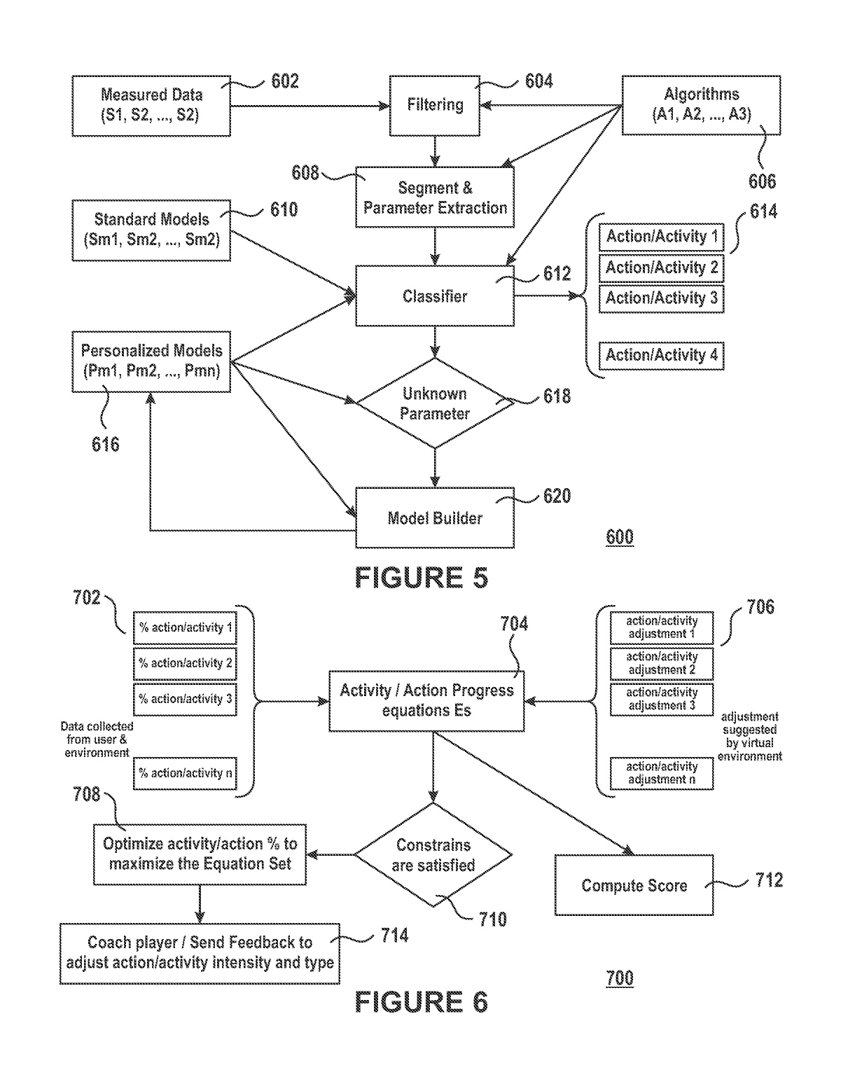

FIG. 5 illustrates the method for filtering, segmenting and classifying received sensor data. This filtering, segmenting and classifying process 600 can be accomplished either by the processor 208 in the physical toy 200 or externally in the processor of the portable electronic device 500 depending on the processing requirements of the given activity. The activity recognition function is used to identify the context in which the physical player 400 has been active. The recognized activity or action 614 will be used to promote, encourage or discourage a particular lifestyle during course of the game in both the physical and the virtual world. The collected data from sensors 602 is filtered using a filtering algorithm 604 that filters both high and low frequency noises. Then, the filtered signal is segmented using a time series segmentation algorithm 608, which takes first marks the interest points of each signal channel and then extracts the segments among each two consecutive interest points. The segmented data is classified using a combination of supervised and semi supervised methods 612. A set of algorithms 606 control filtering, segmenting and classifying the measured sensor data 602. A set of standard models 610, previously identified, is used for both labeling and supervised classification into recognized activities. After the classification is done, each segment is paired 614 with its corresponding class of known activity. Not all segments will be classified. An unsupervised method will be used to cluster those unrecognized segments 618 and the result of the clustering is used to verify the actual state. Once the actual state is identified, a new set of personal models 616 are constructed using the model builder module 620 for each group of activities/actions. Note that a newly created activity will be used to construct the personalized models 616 for the current user 400.

Activity Suggestion/Coaching and Enforcement.

FIG. 6 illustrates the activity suggestion/coaching and enforcement module 700 that delineates a method for determining the progress towards completion of defined activities. Based on the initial system configuration, the challenge engine 304 develops a set of tasks or activities 702 for the user 400 to perform in order to reach a desired goal. Two way communications between the physical user 400 and the virtual avatar 302 may occur through the physical toy 200. The physical toy 200 can instruct the user 400 to accomplish certain tasks (i.e., run in place for ten minutes). The activity/learning recognition module 600 will sense activity performed by the user 400 in the real world and classify the activity into known actions 614. The activity suggestion/coaching and enforcement module 700 can use the classified action/activity information 614 to determine the extent of the activity completion using the activity/action progress equations 704. The evaluation module 710 will determine if the activities performed 702 meet the constraints established. Based on the extent of completion a score 712 will be computed. If the activity suggestion/coaching and enforcement module 700 determines that the user 400 will not meet the constraints set for the current activity, the module will recommend different actions or adjust the activity requirements 706 to meet the threshold requirements of that activity.

The physical player's daily activity 702 is used to boost the energy level of the virtual avatar 302. For example if the user 400 is lazy and does not satisfactorily perform the physical tasks, the virtual avatar 302 will also be lazy and will either prohibit or limit virtual game play. Meanwhile the score 712 of virtual avatar 302 collected in the gaming session is used identify the new set of activity suggestions 714 for the physical user 400 to perform, which will get communicated directly or indirectly through the physical toy 200. This enables coaching of the user 400 by the virtual avatar 302 to meet specified goals. In data collected from the user 400, a percentage of completion or achievement of an activity is computed. Then, the recommended adjustment for each activity 708 is suggested by the virtual environment 300 to compute the required level of progress. If the constraints imposed by player's constraints are not satisfied, then the percentage for each action/activities will get adjusted 708 and communicated to the user 400.

Sensing:

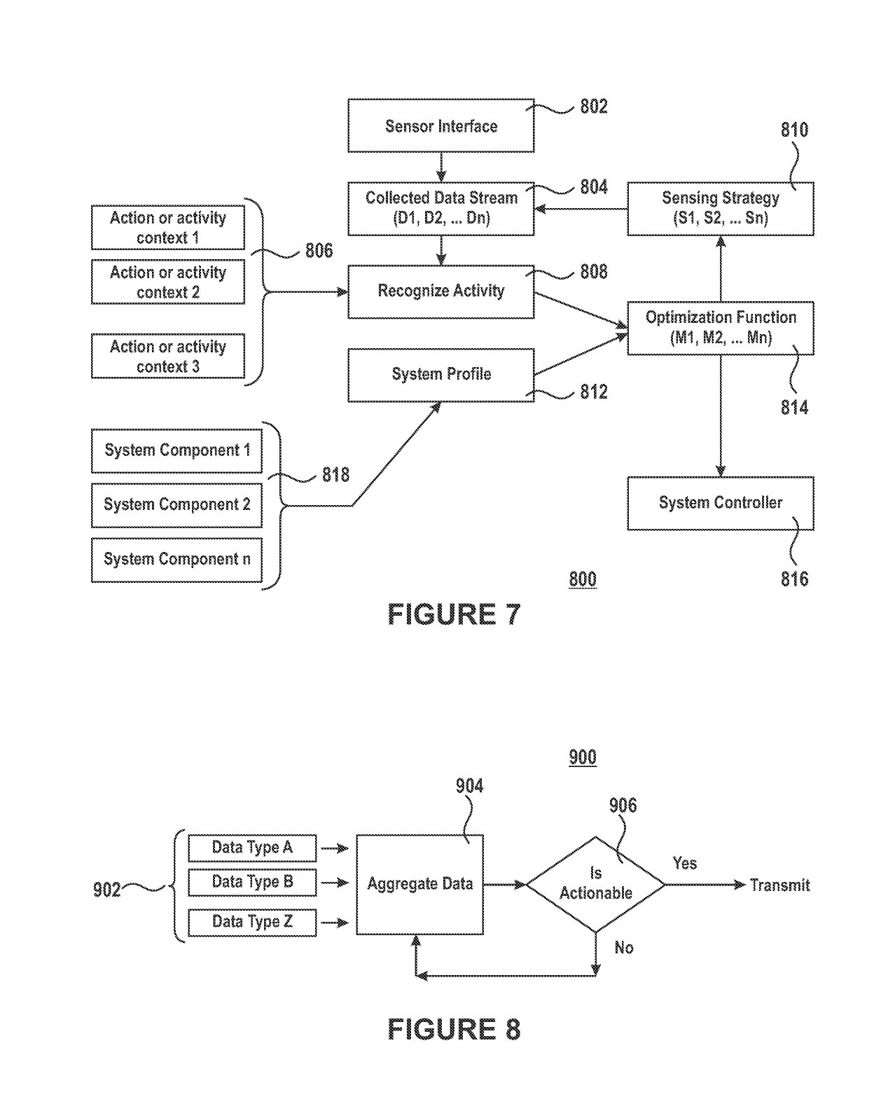

FIG. 7 illustrates the method of optimizing energy consumption by the apparatus 200 during sensor data collection in the sensing module 800. The sensors 206 on the physical toy 200 are controlled in the sensing module 800 by selecting a strategy 810 that optimizes the energy consumed by the physical toy 200 and the volume of data collected 804. Different sensing strategies 810 can be employed i.e., adaptive sampling, opportunistic sampling, probabilistic sampling. Using the collected data 804, the sensing module 800 first identifies the action or context 806 corresponding to the segment of collected data 804. Then, the recognized context 808 along with system parameters 818 are used to determine if the current system profile 812 is optimized 814 above some acceptable threshold. If the function is not above some threshold, then both the sensing strategy controller and the system controller 816 will be used to adjust corresponding parameters to be able to minimize energy consumption.

Transmitter/Receiver:

FIG. 8 illustrates transmitter/receiver module 900 that classifies data into actionable or non-actionable events to determine transmission of data. The segmented and classified collected data stored 902 inside the toy 200 is grouped in aggregate groups 904 and no data is transmitted if the classified data collectible from sensors 206 is classified as “not actionable” by the decision module 906. In this context, actionable means that based on a unit of transformed information, a decision can be made in the virtual experience 300. Classification of data as actionable/non-actionable avoids transmitting data that is not going to be used by the virtual environment 300.

Adaptive Story.

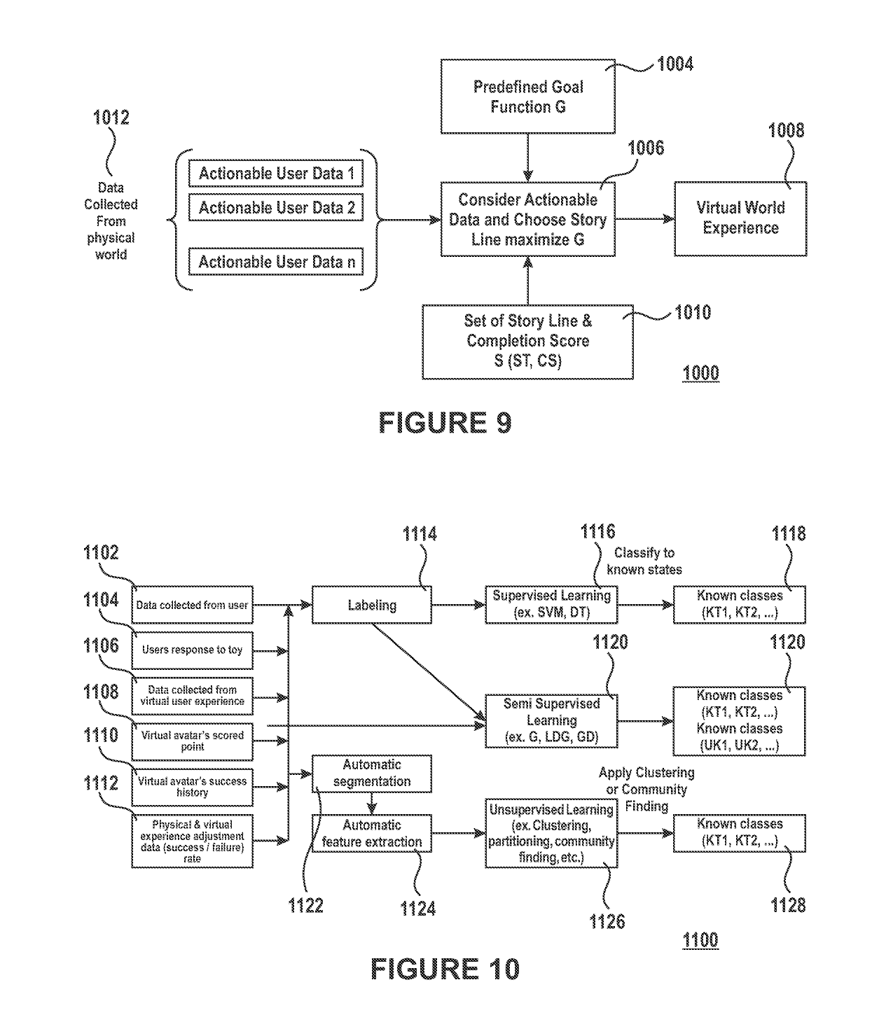

FIG. 9 illustrates the adaptive story module 1000 that provides a method of determining a virtual storyline 1010 to help a user 400 achieve a predefined goal 1004. The storyline 1010 in the virtual world 300 changes adaptively based on recorded actionable user data 1012 before the game session. A maximization process takes the actionable user data 1012 and tries to find a storyline 1010 for the virtual world experience 1008 when completion of that storyline 1010 benefits the user 400 and places the user 400 closer to achieving the predefined goal 1004. The optimization algorithm 1006, depending on an objective function, is either a combinatorial or continuous optimization approach.

Information Mining and Learning Classification Module.

FIG. 10 illustrates the information mining and learning classification module 1100 that provides various methods for information mining. During the life of the game, physical 1112 and virtual data 1106 from several sources will be collected and stored. The information mining and learning classification module 1100 collections data from the user 1102, user's responses 1004 to the physical toy 200, data from the virtual experience 1106, the virtual avatar's scored points 1108, the virtual avatar's success history 1110, and the physical and virtual avatar's experience adjustment data (success/failure rates) 1112. The data is categorized in two parts: raw data and processed data. Raw data is the collected data from the user 400 without applying any decision making process. Raw data can be physiological or environmental data or a single score for a game scenario. The processed data is the result of applying an algorithm to raw data. Data collected from the user 1102, the user's response to toy, data collected from virtual game experience, points scored by virtual avatar, and rates of success 1112 after a proposed adjustment to physical or virtual experience, can individually or collectively form either a raw or a processed data set. The data set is used along with several learning and clustering algorithms to classify actions and behaviors to a known action or behavior or to discover a new and unknown action or behavior.

Depending on the system configuration, several operational modes are possible:

Offline discovery: The learning, classification and discovery happens offline when the user 400 is not active in the gaming experience 300.

Online discovery: The learning, classification and discovery happen during the virtual gaming experience when the user 400 is in the process of playing the game.

Supervised Learning 1126: In the supervised approach, the data is labeled 1114 by a domain expert and labeled data is used by the learning algorithm to train the model. Then, the model is used to classify the future collected data in known classes 1128. For example, the signal data may be labeled as consistent with a user 400 jumping with the physical toy 200. This type of learning requires expert models to detect something where there is a prior knowledge.

Semi-Supervised 1120: In this approach, both labeled 1114 and unlabeled data is used for training. Typically, a small amount of labeled data 1114 with a large amount of unlabeled data. In this mode you both have labeling, similar to the supervised learning, plus the addition of some unsupervised learning.

Unsupervised: There is no labeling requirement. The input data is segmented and an intermediate representation of the data is constructed, then clustering, portioning, graph partitioning or community finding algorithms are used to detect known similar class of actions and activities. For example, if the system detects some aspect of a measured signal i.e., such as period of a signal, or amplitude of signal, something signal dependant. These signals by themselves have no semantic meaning. The meaning is in the context of the signal. The algorithm will cluster different features together based on different similarity functions. The system would therefore have similar concepts grouped together. For example if we have unsupervised learning and have some clustered activities which represents jumping on one leg. If this activity is learned, moving forward the system would be able to identify the signals for jumping on one leg in the supervised learning mode.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is claimed is:

1. A non-transitory computer readable medium storing a program causing a computer to execute a process, the process comprising:
instruction for receiving a plurality of sensor data from a remote apparatus;
instruction for filtering noise from the sensor data;
instruction for segmenting the filtered sensor data into a plurality of discrete activities;
instruction for categorizing the discrete activities;
instruction for determining if the discrete activities meet a predetermined set of criteria;
instruction for depicting a graphical virtual environment;
instruction for rewarding accomplishment of the set of criteria following the completion of activities through a virtual representation in the virtual environment.

2. The computer readable medium according to claim 1, the process further comprising:
instruction for recommending a set of virtual world actions for achieving the set of criteria.

3. The computer readable medium according to claim 1, the process further comprising:
instruction for recommending a set of real world actions for achieving the set of criteria.

4. The computer readable medium according to claim 3, the process further comprising:
instruction for recommending a set of real world actions for achieving the set of criteria by communicating through the remote apparatus.

5. The computer readable medium according to claim 1, the process further comprising:
instruction for a game where a score is determined by a combination of a plurality of real world activities and a plurality of virtual world activities.

6. The computer readable medium according to claim 1, the process further comprising:
instruction for a game where a score is determined by an elapsed time required to complete a specified set of actions.

7. The computer readable medium according to claim 1, the process further comprising:
instructions for presenting a plurality of challenges in the virtual environment that can be scientific, mathematical or social in nature.

8. The computer readable medium according to claim 1, the process further comprising: wherein said process is configured to be executed on a portable electronic device.

9. An apparatus for use in interactive game play, said apparatus comprising:
a body made of hard or soft materials;
a plurality of embedded sensors affixed to the body;
a processor capable of filtering, segmenting, and classifying the sensor data;
a storage device to save processed sensor data; and
an input/output connection.

10. The apparatus of claim 9, wherein one of the sensors comprises an accelerometer.

11. The apparatus of claim 9, wherein one of the sensors comprises a microphone.

12. The apparatus of claim 9, wherein one of the sensors comprises a light sensor.

13. The apparatus of claim 9, wherein one of the sensors comprises a pressure sensor.

14. The apparatus of claim 9, wherein one of the sensors comprises a gyroscope.

15. The apparatus of claim 9, wherein one of the sensors comprises a magnetometer.

16. The apparatus of claim 9, further comprising a wireless transmitter and receiver for exchanging data over short distances.

17. The apparatus of claim 9, further comprising an external connector for a portable electronic device.

18. The apparatus of claim 9, wherein a portable electronic device comprises the processor.

19. The apparatus of claim 9, wherein a portable electronic device can be removeably affixed to the body.

20. The apparatus of claim 9, wherein the sensor information can be transmitted in near-real time.

21. The apparatus of claim 9, wherein the sensor information can be transmitted through the output connection.

22. The apparatus of claim 9, wherein the sensor information can either be transmitted in near-real time or transmitted time late.

23. The apparatus of claim 9, wherein the sensor data is collected through use of adaptive sampling, opportunistic sampling, or probabilistic sampling techniques.

24. An interactive system for education and entertainment, comprising:
An apparatus for use in interactive game play, said apparatus comprising:
a body made of hard or soft materials;
a plurality of embedded sensors affixed to the body;
a processor capable of filtering, segmenting, and classifying the sensor data;
a storage device to save processed sensor data;
an input/output connection;
a charging and data transfer station;
a computer program product for processing sensor data, the computer program product being encoded on one or more machine-readable storage media and comprising:
instruction for receiving a plurality of sensor data from a remote apparatus;
instruction for filtering noise from the sensor data;
instruction for segmenting the filtered sensor data into a plurality of discrete activities;
instruction for categorizing the discrete activities;
instruction for determining if the activities meet a predetermined set of criteria;
instruction for depicting a graphical virtual environment;
instruction for rewarding accomplishment of the set of criteria following the completion of activities through a virtual representation in the virtual environment.

25. A computer implemented method suitable for implementation on a processor comprising:
receiving a plurality of sensor data from a remote apparatus;
filtering noise from the sensor data;
segmenting the filtered sensor data into a plurality of discrete activities;
categorizing the discrete activities;
determining if the activities meet a predetermined set of criteria;
depicting a graphical virtual environment;
rewarding the accomplishment of the set of criteria following the completion of activities through a virtual representation in the virtual environment.
wherein said receiving, filtering, segmenting, categorizing, determining, depicting and rewarding is performed by the processor.

26. The method of claim 25, further comprising:
recommending a set of virtual world actions for achieving the set of criteria,
wherein said recommending is performed by the processor.

27. The method of claim 25, further comprising:
recommending a set of real world actions for achieving the set of criteria,
wherein said recommending is performed by the processor.

28. The method of claim 25, further comprising:
recommending a set of real world actions for achieving the set of criteria by communicating through the remote apparatus,
wherein said recommending is performed by the processor.

29. The method of claim 25, further comprising:
determining a score by a combination of a plurality of real world activities and a plurality of virtual world activities,
wherein said determining is performed by the processor.

30. The method of claim 25, further comprising:
determining a game score by an elapsed time required to complete a specified set of actions,
wherein said determining is performed by the processor.

31. The method of claim 25, further comprising:
presenting a plurality of challenges in the virtual environment that can be scientific, mathematical or social in nature,
where said presenting is performed by the processor.
